(19) United States
(12) Patent Application Publication
(10) Pub. No.: US 2005/0076667 A1
(43) Pub. Date: Apr. 14, 2005

(54) Apparatus and method for hydraulically interconnecting a bottled water dispenser with an automatic ice maker and water chiller

(76) Inventor: Ralph E. Deem JR., Stockton, CA (US)

Correspondence Address: R. MICHAEL WEST LAW OFFICES OF;R. MICHAEL WEST, A PROFESSIONAL CORPORATION, 455 CAPITOL MALL; SUITE 405, SACRAMENTO, CA, 95814-4603, US

(21) Appl. No.: 10/683,978

(22) Filed: Oct. 10, 2003

(51) Int. Cl. B67D 5/62

(52) U.S. Cl. 62/389; 62/391; 222/146.6

(57) ABSTRACT

An apparatus and method for hydraulically interconnecting the reservoir of a water dispenser with an ice maker or a water chiller of a refrigerator. Each water delivery system of the refrigerator is modified by replacing the water supply line solenoid valve with an electrical pump. The hydraulic output of the pump is connected to the water recharge line, leading either to the ice maker or to the water chiller. The wiring harness formerly connected to the solenoid is connected directly to the pump motor. An adapter including a bottle support ring is installed between the water bottle and the dispenser. A water supply line passes transversely through support ring. A feed portion of the water supply line is immersed in the water contained within the dispenser. A delivery portion of the water supply line extends outside the dispenser, and is interconnected to the hydraulic input of the new water pump.

### BACKGROUND OF THE INVENTION

1. Field of the Invention

The invention relates generally to apparatus for providing high quality water to a refrigerator having one or more water utilization accessories. More particularly, the invention pertains to an apparatus comprising an adapter for independently drawing water from a bottled water dispenser, and a refrigerator with modified internal ice maker and water chiller delivery systems for receiving water from that dispenser.

2. Description of the Prior Art

The prior art teaches the concept of providing an outside water source, other than tap water supply, to the ice maker or water chiller of a refrigerator. For example, in U.S. Pat. No. 4,987,746, granted to Roberts, an Apparatus For Transferring Water From A Container To A Refrigerator Ice Maker is shown. Roberts uses an electric pump, mounted on the top of an auxiliary water bottle. The pump is outside the refrigerator, thereby requiring that a power line pass through the wall of the refrigerator to interconnect to the internal control timer.

U.S. Pat. No. 4,207,994, granted to Offlee, Sr., discloses Refrigerator Systems Utilizing Assemblies To Enable Dispensing Cold Water Or Ice Made From Purified Water. In this assembly, a water bottle is combined with a chiller, a spigot, and a pump. The pump is controlled by electric power going to a solenoid valve in the refrigerator.

A Bottled Water Pumping Apparatus is shown in U.S. Pat. No. 4,941,806, issued to Brown et al. The apparatus is self contained, including the water bottle, a power supply with control circuits, and a pump. The pump is controlled by a pressure actuated switch of conventional design, which relies upon a power source which is external to the refrigerator.

U.S. Pat. No. 4,027,499, issued to Barto et al., shows a Refrigerator Water Reservoir Assembly For Automatically Supplying Water To The Ice Maker From The Reservoir. In this arrangement, a reservoir located on top of the refrigerator includes a pump. The pump is powered by the timer controlling the ice maker. Water is pumped into the reservoir for storage, and then fed into the ice maker by gravity.

A Bottled Water Delivery System is shown in U.S. Pat. No. 5,901,880, issued to Clarke. An upended bottle includes a water feed tube and pump control components which pass through the neck of the bottle. A separate box includes the pump and power supply components. The water outputted by the system is directly connected to a refrigerator.

U.S. Pat. No. 5,558,256, granted to Miller et al., discloses a Bottled Water Supply System. A pressure demand pump is mounted above a water bottle, having an input line in fluid communication with the water in the bottle. The output line goes to a “T” fitting, with one leg feeding a faucet and the other leg feeding the water chiller in a refrigerator. The pump is powered independently, by 120 volt ac from a wall socket.

A Water Delivery & Dispensing System is shown in U.S. patent application Publication, US 2001/0030201 A1. A pump is located in the bottom of a water bottle. Actuation of the pump is dependent upon a pressure switch responsive to a drop in pressure in the output line.

The need still exists, however, for an automatic ice maker which is supplied with pure bottled water, rather than tap water.

The need also exists for an apparatus and a method which allow the quick and inexpensive modification of the existing internal automatic ice maker and water chiller systems of a refrigerator, so they will operate on pure water which is supplied from an external bottled water dispenser.

The need also exists for an apparatus and a method for replacing an existing solenoid valve in the ice maker or the water chiller systems with an electric pump, in which the electric pump is mounted within the refrigerator using the existing power and control circuits for the solenoid valve.

The need further exists for a ring adapter and a water infeed line for use with an existing water dispenser, allowing the independent withdrawal of pure water from the reservoir of the water dispenser without interfering with the dispenser's normal use.

These and other objects will be described below in the drawings and the detailed description of the preferred embodiment to follow.

### SUMMARY OF THE INVENTION

The typical refrigerator, equipped with one or more water utilization accessories, such as an automatic ice maker or a water chiller, relies upon pressurized tap water for its water source. Public tap water in most communities is chlorinated, and it may also include other minerals or impurities in amounts which people find distasteful or unhealthy. Some tap water also exhibits an odor which is unpleasant to consumers. Privately owned wells may also provide tap water which suffers from the same lack of quality. When this inferior tap water is fed into ice maker or water chiller of a refrigerator, the resultant ice and chilled water exhibit the same quality characteristics as the tap water supplied to the appliance.

Each of the water delivery systems of the refrigerator ice maker and water chiller includes an electronic solenoid valve. The main purpose of the valve is to isolate the ice maker and the water chiller from the pressurized tap water, except when recharging of the system is necessary. For example, after an ice maker has dispensed ice, it goes through a recharging cycle during which water is fed into its ice forming molds for a predetermined period of time. For that purpose, an electrical timer delivers 120 volt ac to the solenoid valve, thereby opening the valve and allowing tap water to recharge the ice maker. After a number of seconds have elapsed, the timer interrupts the power to the solenoid valve, and the valve resumes its normally closed position. Similarly, water chillers have an “on demand” push button switch, providing electricity to actuate a solenoid valve. As long as the solenoid valve is actuated into its open position, tap water is delivered into the water chiller recharge line.

In accordance with the teachings of the present invention, the existing water delivery system of the refrigerator is modified so it can accept pure water, provided by a secondary source. That secondary source of water is a bottled water dispenser, also modified through the use of a special adapter. The adapter requires no special tools or skills to install, is removed in seconds, and does not interfere in any way with the existing manual valve operation of the water dispenser.

The modification of the water delivery system(s) is straightforward. The existing solenoid valve is physically removed and replaced with a small electrical pump. Depending upon the particular refrigerator, a separate mounting bracket may be necessary to secure the pump in the location previously occupied by the solenoid. The hydraulic output of the pump is connected to the water recharge line, leading either to the automatic ice maker or to the water chiller. Because the pump is powered by 120 volt ac, all of the existing control circuitry, wire harness, and connectors which previously were used to actuate the solenoid, may be utilized to actuate the pump motor without any modification. The slip-on power connectors are simply reattached to terminals on the pump motor. In this manner, the pump will be actuated in the same manner and for the identical duration as the solenoid valve was prior to the modification.

The new, secondary source of water to be provided to the pump comes from the water reservoir of a bottled water dispenser. Preferably, the homeowner or the business where the refrigerator is located has an existing bottled water dispenser, available to be modified. This modification is also simple, requiring the installation of a special adapter between the neck of the upturned plastic bottle and the upper rim of the dispenser.

The adapter includes a bottle support ring, which is sized and configured to rest over the upper rim of the bottled water dispenser. The lower side of the support ring thereby provides a seal over the upper rim of the dispenser. The adapter also includes a water supply line, which passes transversely through support ring. A feed portion of the water supply line extends into the bottled water dispenser and is immersed in its water reservoir. A delivery portion of the water supply line extends outside the bottled water dispenser, and is interconnected to the hydraulic input of the electrical water pump in the modified refrigerator.

When the bottle of water is upended for installation over the dispenser, the neck of the bottle is positioned over the upper side of the support ring. Preferably, the support ring is somewhat resilient, providing sanitary seals between the dispenser and the lower side of the ring, and between the upper side of the ring and the neck of the bottle.

Bottled water contained in the dispenser is thereby provided to the hydraulic input of the pump, and then is injected into the ice maker or the water chiller through the pressure provided by the pump. The adapter does not interfere with the normal operation of the dispenser, so the user may dispense water through the manual valve located in the lower portion of the dispenser, as before. And, the adapter may be removed easily for cleaning, if necessary.

### BRIEF DESCRIPTION OF THE DRAWINGS

FIG. 1 is a left front perspective view of a water dispenser and a bottle of water including the adapter of the present invention, with the delivery portion of the water supply line interconnected to the modified refrigerator;

FIG. 2 is an exploded perspective view of the water dispenser, the adapter with the water supply line, and a water bottle;

FIG. 3 is right-rear perspective view of an unmodified refrigerator, equipped with two solenoid valves;

FIG. 4 is right-rear perspective view of a partially modified refrigerator, showing the upper solenoid valve removed and a pump mounting bracket installed;

FIG. 5 is a right-rear perspective view of a partially modified refrigerator, showing the upper pump installed and the lower pump ready to be installed on a pump mounting bracket;

FIG. 6 is a right-rear perspective view of a fully modified refrigerator, showing both the upper and lower pumps installed with all hydraulic lines and power line wire harnesses connected;

FIG. 7 is a partial electrical schematic for typical unmodified prior art refrigerator;

FIG. 8 is a partial electrical schematic for a modified refrigerator, showing the interconnection with the new ice maker pump; and,

FIG. 9 is a partial electrical schematic for a modified refrigerator, showing the interconnection with the new water chiller pump.

### DETAILED DESCRIPTION OF THE PREFERRED EMBODIMENT

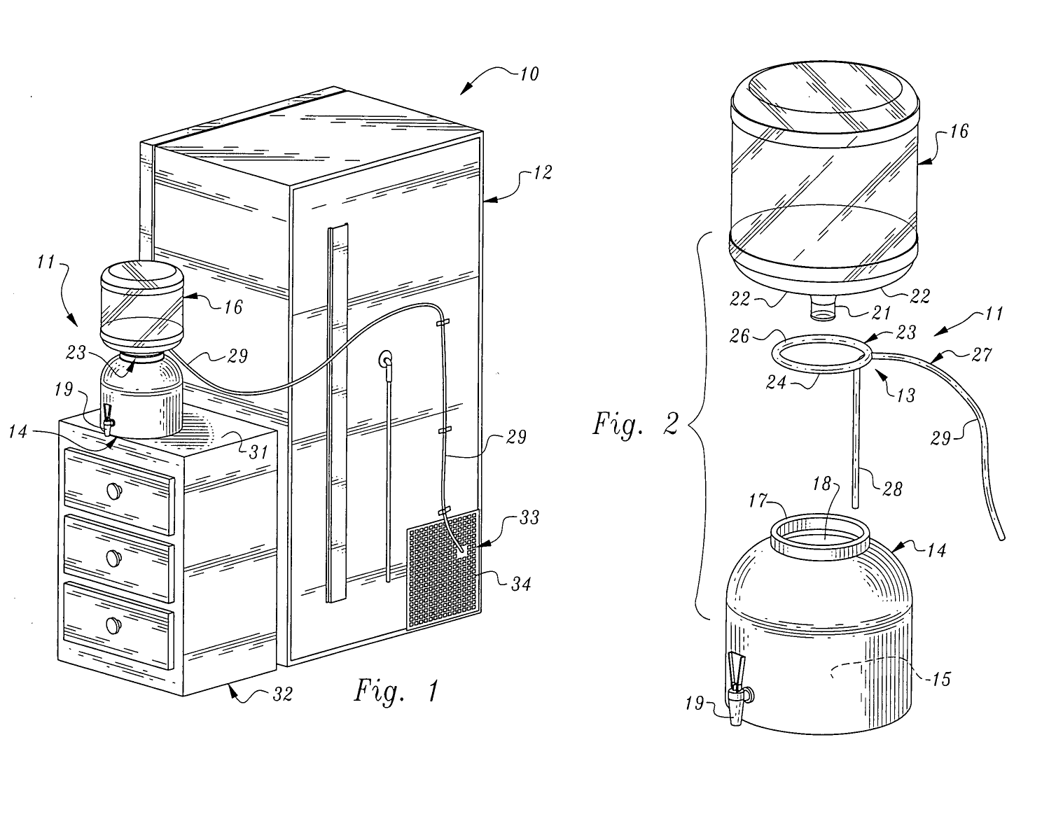

Turning now to the drawings, and in particular to FIG. 1, an apparatus 10 for hydraulically interconnecting a bottled water dispenser with a refrigerator having a modified water delivery system for an ice maker or a water chiller is disclosed. The apparatus 10 generally comprises bottled water containment means 11 and a modified refrigerator 12. Containment means 11 includes an adapter 13, a bottled water dispenser 14 having a reservoir 15, and a bottle 16. The bottle 16 preferably contains spring or purified water, at least a portion of which is stored within reservoir 15. Dispenser 14 is of conventional construction, having an upper rim 17 surrounding an opening 18. Dispenser 14 is also provided with a spigot 19, for the selective discharge of contained water. Bottle 16 includes a neck 21 and shoulder portion 22. Bottle 16 may be of any size, but a 3 to 5 gallon capacity per bottle, is typical for home and office use.

Adapter 13 includes a bottle support ring 23, which is sized and configured to rest over the upper rim 17 of dispenser 14. Ring 23 is preferably made entirely from a resilient material, such as plastic, rubber, or foam, but other combinations of rigid and resilient material would function equally well. Irrespective of the specific material or manner of construction employed, ring 23 must be sufficiently strong to support the weight of a bottle 16 full of water, without substantially deforming.

Ring 23 has a lower side 24, which forms a sanitary seal with upper rim 17, and an upper side 26, which forms a sanitary seal with shoulder portion 22 of bottle 16. The diameters of the lower and upper sides of ring 23 may be different, to accommodate rims and shoulder portions which are of different sizes. In addition to forming a seal between the bottle 16 and the dispenser 14, ring 23 maintains the shoulder portion 22 of the bottle 16 in spaced relation above the upper rim 17 of the dispenser. The spaced relation between portion 22 and rim 17 is sufficient to allow the transverse passage of a water supply line 27 through ring 23. Water supply line 27 is preferably made from flexible plastic tubing, to allow convenient location of the line 27 in a variety of circumstances. If longer distances are to be spanned by line 27, or where the line 27 is to pass through walls or other building structures, copper tubing may be more appropriate than plastic tubing.

As shown most clearly in FIG. 2, line 27 includes a feed portion 28 extending into the dispenser 14, and a delivery portion 29 extending outside the dispenser. Feed portion 28 is of sufficient length to locate its lower end near the bottom of the reservoir 15 of dispenser 14, when the adapter 13 is installed over the rim 17 of the dispenser. In that location, the lower end of feed portion 28 will be immersed in water as long as the reservoir 15 contains at least some water.

Installation of the bottle 16 over the dispenser 14 with the adapter 13 installed is accomplished in exactly the same way as before the adapter was installed. The bottle 16 is upended and lowered over the adapter 13, where it is fully supported by the ring 23. The operation of the dispenser 14, resting on the upper surface 31 of a cabinet 32, is exactly the same as it was before the installation of the adapter 13. The user simply places a container below the spigot 19 and opens the spigot until the desired amount of water is dispensed.

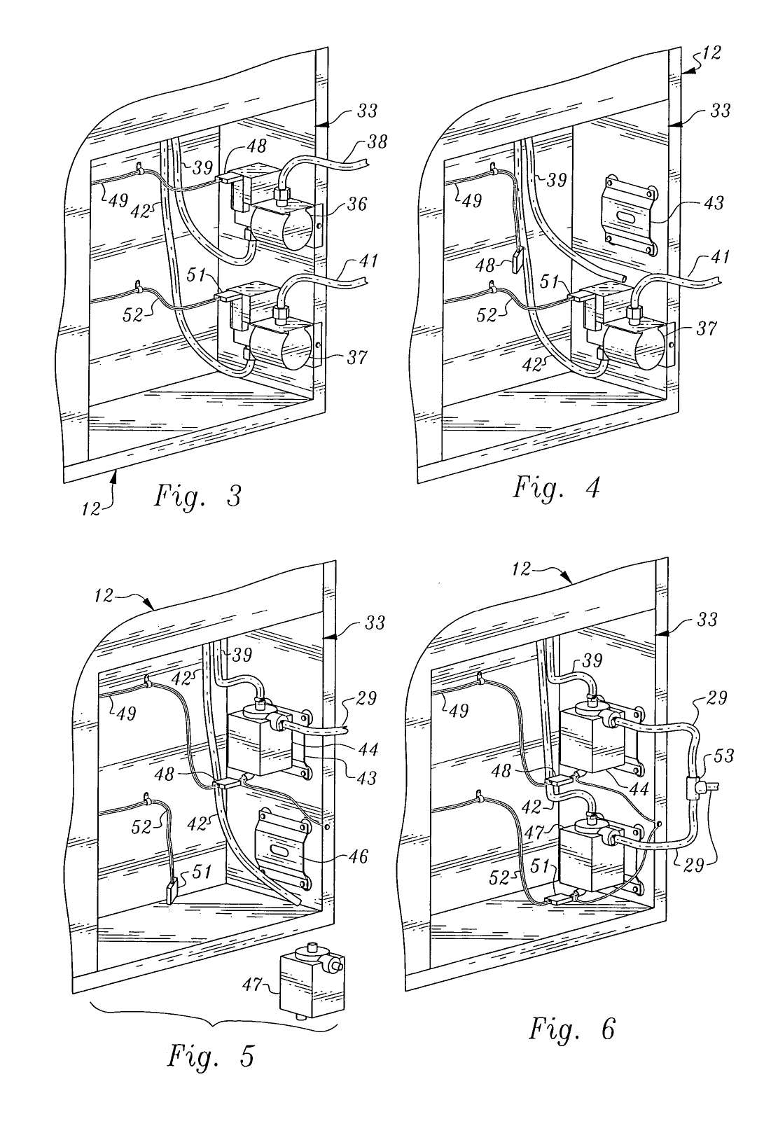

The delivery portion 29 of the adapter 13 is of sufficient length to extend a foot or so into the component housing 33 of the refrigerator 12. Removing the perforated cover 34 from the opening of the housing 33, reveals the automatic ice maker solenoid 36 and the water chiller solenoid 37. (See, FIG. 3). Ice maker solenoid 36 is interposed between a water inlet line 38 and a water recharge line 39. Water inlet line 38 is connected to the home or business tap water line, which typically provides water to the refrigerator 12 under approximately 40-50 psi. Water recharge line 39 is connected to the mold in the automatic ice maker mechanism (not shown) within the freezer portion of the refrigerator.

Similarly, water chiller solenoid 37 has its inlet connected to water inlet line 41 and its outlet connected to water recharge line 42. The water inlet line 41 is connected to the tap water line, providing pressurized tap water to the solenoid 37. Water recharge line 42 passes through various chilled areas of the refrigerator's interior, and eventually interconnects to the water chiller mechanism. (not shown).

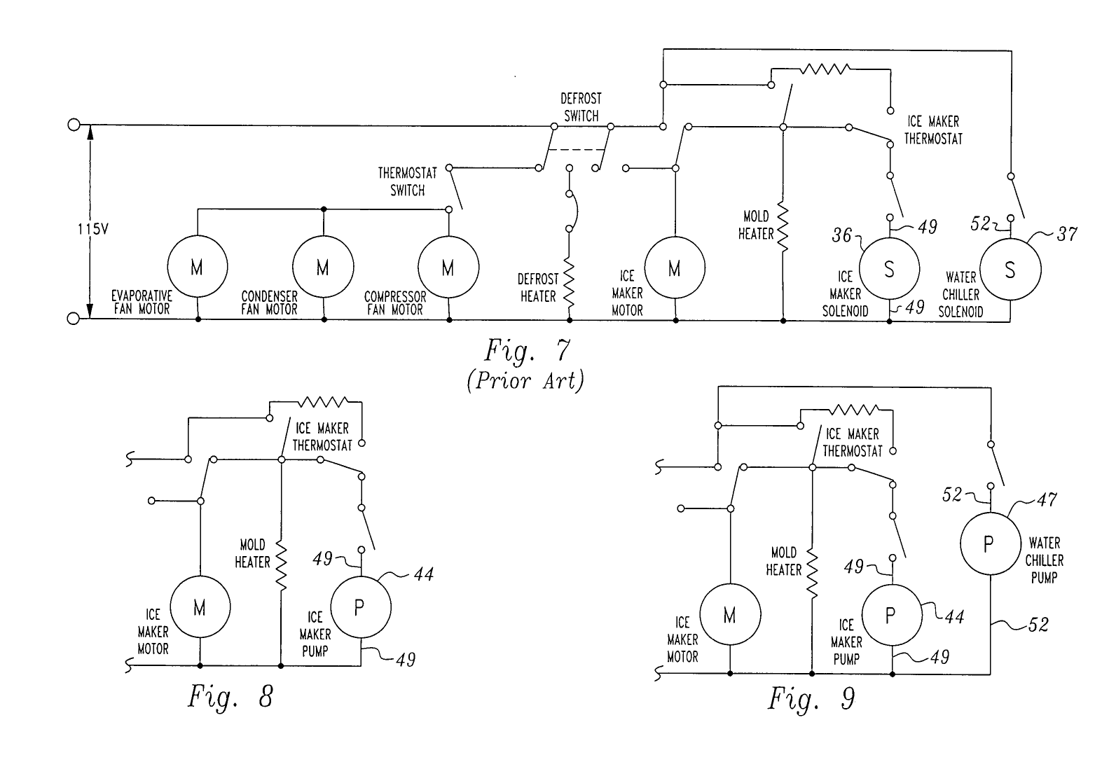

A partial, pictorial schematic of a typical prior art refrigerator is shown in FIG. 7. This particular refrigerator includes both an automatic ice maker and a water chiller as accessories. However, the present invention may be used advantageously in connection with refrigerators having one, the other, or both of these accessories. The most of components in this schematic are simply identified with their common designations or by the appropriate electrical symbol, for clarity and ease of understanding. In addition, the letter “M” is used to indicate a motor, and the letter “S” is used to indicate a solenoid. It should also be noted that the letter “P” is used to designate the pumps in FIGS. 8 and 9.

An electrical connector 48 is provided on the end of the automatic ice maker power line or wiring harness 49, and an electrical connector 51 is provided on the end of the water chiller wiring harness 52. These components comprise the original electrical control circuits for the two solenoids. Connectors 48 and 51 simply plug into respective receptacles in ice maker solenoid 36 and water chiller solenoid 37. Both solenoids have a normally closed position, so that only upon being energized by power provided through lines 49 and 52, will the solenoid valves open to allow the pressurized water to enter the water utilization accessory.

To carry out the process of modifying the refrigerator 12 in accordance with the present teachings, lines 38 and 39, and electrical connector 48, are disconnected from the ice maker solenoid 36. Then, solenoid 36 is removed from housing 33. In its place, a pump bracket 43 may be installed, if necessary. Some pumps may have their own mounting base integral with the pump, dispensing with the necessity of a separate pump bracket. Similarly, lines 41 and 42, and connector 51, are disconnected from the water chiller solenoid 37, before the solenoid 37 itself is removed. A pump bracket 46 may be installed in the former location of the solenoid 37.

As shown in FIGS. 5 and 6, an ice maker pump 44 is installed over bracket 43, and a water chiller pump 47 is installed over bracket 46. Both pump 44 and pump 47 are located in the component housing 33 of the refrigerator, in proximity to their respective wiring harnesses and their respective water recharge lines. Pumps 44 and 47 are preferably of identical design, each having an electrical input to provide power to the pump's motor, a hydraulic input for receiving water, and a hydraulic output for discharging water under pressure. The electrical inputs for the pumps have connector terminals which are identical to those on the solenoids which were just removed. By simply plugging connectors 48 and 51 onto the connector terminals for the pumps 44 and 47, the respective electrical control circuits which formerly energized the solenoids, will now energize the pumps.

In addition, the water recharge line 39 is connected to the hydraulic output of the water pump 44, and the water recharge line 42 is connected to the hydraulic output of the water pump 47. The delivery portion 29 of the water supply line 27 is connected to a “T” fitting 53. Respective portions 29 on the output side of fitting 53, are interconnected to the hydraulic inputs of pumps 44 and 47.

When the apparatus 10 is initially placed into service, the water supply line 29 may have to be charged with water, unless the pumps 44 and 47 are self-priming. If the pumps are self-priming, the reservoir 15 could actually be lower in elevation than the pumps, and the apparatus would still function satisfactorily. A check valve (not shown) placed in series with the water supply line 29 may assist in maintaining pump prime. A check valve may also be used advantageously in water supply line 29 to prevent water leakage through the pump, where the reservoir is located above the ice maker or water chiller. Assuming that the reservoir is located above the elevation of the pumps, the bottled water will continuously be fed into the pumps, either by gravity alone or by the combination of gravity and siphon. With water always present at the inputs of the pumps, when a deficiency of water in either the ice maker or the water chiller is detected or determined, the appropriate water pump will be actuated and bottled water will be provided to the accessory. Since water for the refrigerator accessories is drawn from the dispenser 14 completely independent of usage or interconnection with the spigot 19, there is no interference or impairment of normal use of the dispenser as a reservoir and as a dispenser of water.

It will be appreciated, therefore, that I have disclosed an apparatus and method for hydraulically interconnecting a bottled water dispenser with a refrigerator having water utilization accessories such as an automatic ice maker or a water chiller.

1. An adapter for drawing water from a bottled water dispenser having an upper rim surrounding an opening, comprising:
a. a bottle support ring, said ring being sized and configured to rest over the upper rim of the bottled water dispenser; and,
b. a water supply line, said line passing transversely through said support ring, defining a feed portion extending into the bottled water dispenser and a delivery portion extending outside the bottled water dispenser.

2. An adapter as in claim 1 in which said ring is made from a resilient material, sufficiently strong to support the weight of a bottle of water without substantially deforming, and in which said water supply line is made from plastic tubing.

3. An adapter for drawing water from a bottled water dispenser having an upper rim surrounding an opening, and an upended bottle of water having a neck inserted in the opening of the water dispenser, comprising:
a. support means for maintaining a bottle of water in spaced relation above the upper rim of the bottled water dispenser, said support means further providing a seal between a shoulder of the bottle and the upper rim of the bottled water dispenser; and,
b. a water supply line passing transversely through said support means, said water supply line having a feed portion extending into the bottled water dispenser and a delivery portion extending outside the bottled water dispenser.

4. An apparatus for providing bottled water to a refrigerator, comprising:
a. a water utilization accessory inside the refrigerator, said accessory having a water delivery system with a water recharge line, an electrical control circuit providing electrical output for a predetermined period of time in response to a detected deficiency of water within said accessory, and a water pump responsive to said electrical output of said control circuit, said pump further having a hydraulic input and a hydraulic output, said hydraulic output being connected to said water recharge line;
b. a reservoir of bottled water located outside the refrigerator; and,
c. a water supply line extending between said reservoir of water and said hydraulic input of said water pump, said water supply line having a feed portion immersed in said reservoir and a delivery portion extending outside said reservoir to said hydraulic input of said water pump.

5. An apparatus as in claim 4 in which said water utilization accessory is an automatic ice maker.

6. An apparatus for providing bottled water to a refrigerator, comprising:
a. a water utilization accessory inside the refrigerator, said accessory having a water delivery system with a water recharge line, an electrical control circuit providing an electrical output on demand, and a water pump responsive to said electrical output of said control circuit, said pump further having a hydraulic input and a hydraulic output, said hydraulic output being connected to said water recharge line;
b. a reservoir of bottled water located outside the refrigerator; and,
c. a water supply line extending between said reservoir of water and said hydraulic input of said water pump, said water supply line having a feed portion immersed in said reservoir and a delivery portion extending outside said reservoir to said hydraulic input of said water pump.

7. An apparatus as in claim 6 in which said water utilization accessory is a water chiller.

8. An apparatus for providing bottled water to a refrigerator, comprising:
a. a water utilization accessory inside the refrigerator, said accessory having a water delivery system with a water recharge line, an electrical control circuit providing electrical output for a predetermined period of time in response to a detected deficiency of water within said accessory, and a water pump responsive to said electrical output of said control circuit, said pump further having a hydraulic input and a hydraulic output, said hydraulic output being connected to said water recharge line; and,
b. bottled water containment means located outside the refrigerator, said containment means including a water supply line having a feed portion immersed in the contained bottled water and a delivery portion extending outside the containment means, said delivery portion being interconnected to said hydraulic input of said water pump.

9. An apparatus as in claim 8 in which said bottle water containment means comprises a bottled water dispenser, said dispenser including an upper rim surrounding an opening, an adapter including a bottle support ring, said bottle support ring having a lower side installed over said upper rim, said bottle support ring further having an upper side, and said water supply line passing transversely through said bottle support ring.

10. An apparatus as in claim 9 in which said ring is made from a resilient material, sufficiently strong to support the weight of a bottle of water without substantially deforming, and in which said water supply line is made from plastic tubing.

11. A method for modifying a refrigerator having a water utilization accessory inside the refrigerator, the accessory having a water delivery system with a water recharge line, an electrical control circuit providing an electrical output for a predetermined period of time in response to a detected deficiency of water within the accessory, and a solenoid valve responsive to the electrical output of the control circuit, the solenoid valve further having an inlet connected to a pressurized source of water and an outlet connected to the water recharge line, comprising the steps of
a. disconnecting the electrical control circuit from the solenoid valve;
b. disconnecting the inlet of the solenoid valve from the pressurized source of water;
c. disconnecting the outlet of the solenoid valve from the water recharge line;
d. removing the solenoid valve from the refrigerator;
e. installing a water pump in the refrigerator in proximity to the electrical control circuit and the water recharge line, said water pump having an electrical input, a hydraulic input, and a hydraulic output;
f. connecting the electrical control circuit to said electrical input of said water pump; and,
g. connecting the water recharge line to said hydraulic input of said water pump.

12. A method as in claim 11 in which said water utilization accessory is an ice maker.

13. A method as in claim 11 in which said water utilization accessory is a water chiller.

14. A method as in claim 11 further including the step of connecting a water supply line in hydraulic communication with a reservoir of bottled water to said hydraulic input of said water pump.

15. A method as in claim 11 further including the step of installing a pump mounting bracket in the refrigerator at a location in proximity to the electrical control circuit and the water recharge line, after the solenoid valve is removed.

16. A method as in claim 11 in which the refrigerator includes two water utilization accessories, the first of which is an ice maker, and the second of which is a water chiller.
